(19) United States
(12) Patent Application Publication
(10) Pub. No.: US 2009/0085867 A1
(43) Pub. Date: Apr. 2, 2009

(54) Error-correction apparatus and method and 3D pointing device using the error-correction apparatus

(75) Inventors: Won-chul Bang, Seongnam-si (KR); Jing Yang, Beijing (CN); Bin Zhai, Beijing (CN); Youn-bae Kim, Seongnam-si (KR); Sang-on Choi, Suwon-si (KR); Eun-seok Choi, Anyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/076,106

(22) Filed: Mar. 13, 2008

(30) Foreign Application Priority Data
Oct. 2, 2007 (KR) 10-2007-0099261

(51) Int. Cl. G06F 3/033; G06F 11/00

(52) U.S. Cl. 345/157; 714/819; 714/E11.002

(57) ABSTRACT

An error-correction apparatus and method and a three-dimensional (3D) pointing device using the error-correction apparatus are provided. The error-correction apparatus includes a data-collection module which collects current data and calculates an actual variation in the current data; an estimation module which calculates an estimated data variation for the current data based on a number of data variations for respective corresponding previous data; a threshold-calculation module which calculates a variable threshold based on the data variations for the respective previous data; and a determination module which compares the difference between the actual data variation and the estimated data variation with the variable threshold and determines whether the current data is erroneous based on the result of the comparison.

### CROSS-REFERENCE TO RELATED APPLICATION

This application claims priority from Korean Patent Application No. 10-2007-0099261 filed on Oct. 2, 2007 in the Korean Intellectual Property Office, the disclosure of which is incorporated herein by reference in its entirety.

### BACKGROUND OF THE INVENTION

1. Field of the Invention

The present invention relates to an error-correction apparatus and method and, more particularly, to an error-correction apparatus and method and a three-dimensional (3D) pointing device using the error-correction apparatus, in which an error is corrected using a variable threshold.

2. Description of the Related Art

Sensors can detect and measure various physical properties such as magnetism, displacement, vibration, acceleration, number of revolutions, flow rate, flux, liquid components, gas components, visible light, infrared rays, ultrasonic waves, microwaves, ultraviolet rays, radioactive rays, and X-rays. Thus, material used for sensors varies according to the type of physical property to be detected. Sensors are generally designed to output electric signals since electric signals can be easily amplified, stored in a memory, controlled from a remote place, and manipulated with a computer.

As an example, inertial sensors are widely used in various fields. Inertial sensors detect the inertial force of an object, and provide various navigation information such as acceleration, velocity, direction and distance of the object. Inertial sensors detect the inertial force of a moving object caused by the acceleration applied thereto, and can be used in various devices such as airbags, camcorders, mobile phones, game consoles, and three-dimensional (3D) pointing devices.

However, it is well known that measurement results obtained by the sensors may have various errors such as noise, measurement error, and errors caused by mishandling of the sensors. Such errors in the measurement results obtained by the sensors may cause errors in subsequent operations that may be performed using the measurement results. For example, in a 3D pointing device using an inertial sensor, errors such as noise, measurement error, and errors caused by mishandling of the inertial sensor may cause an undesirable pointer movement on a display screen.

### SUMMARY OF THE INVENTION

The present invention provides an error-correction apparatus and method in which an error can be effectively corrected using a sensor.

The present invention also provides an error-correction apparatus and method in which an error is corrected using a variable threshold.

However, the objectives of the present invention are not restricted to the ones set forth herein. The above and other objectives of the present invention will become apparent to one of daily skill in the art to which the present invention pertains by referencing the detailed description of the present invention given below.

According to an aspect of the present invention, there is provided an error-correction apparatus including a data-collection module which collects current data and calculates an actual variation in the current data; an estimation module which calculates an estimated data variation for the current data based on a number of data variations for respective corresponding previous data; a threshold-calculation module which calculates a variable threshold based on the data variations for the respective previous data; and a determination module which compares the difference between the actual data variation and the estimated data variation with the variable threshold and determines whether the current data is erroneous based on the result of the comparison.

According to another aspect of the present invention, there is provided an error-correction method including calculating an actual variation in data currently being collected; calculating an estimated data variation for the current data based on a number of data variations for respective corresponding previous data; calculating a variable threshold based on the data variations for the respective previous data; and comparing a difference between the actual data variation and the estimated data variation with the variable threshold and determining whether the current data is erroneous based on the result of the comparison.

According to another aspect of the present invention, there is provided a three-dimensional (3D) pointing device including an error-correction apparatus, the 3D pointing device including a measurement module which receives acceleration values and angular velocity values of a body frame; a conversion module which converts the angular velocity values of the body frame into angular velocity values of a navigation frame using the acceleration values of the body frame; a rotation-angle-variation-calculation module which calculates rotation angle variations based on the angular velocity values of the navigation frame; a cursor-movement-value-calculation module which calculates a cursor movement value based on the rotation angle variations; and an error-correction apparatus which corrects an error in the cursor movement value using a variable threshold, the variable threshold being determined based on a number of data variations regarding the cursor movement value.

According to another aspect of the present invention, there is provided a 3D pointing device including a sensor module which measures an acceleration and an angular velocity, and outputs the results of the measurement as analog signals; an analog-to-digital (A/D) converter which converts the analog signals into digital signals; a processor which calculates a cursor movement value by processing the digital signals, and corrects an error in the cursor movement value using a variable threshold, the variable threshold being determined based on a number of data variations regarding the cursor movement value; and a memory which stores programs and data that are necessary for an operation of the processor.

### BRIEF DESCRIPTION OF THE DRAWINGS

The above and other features and advantages of the present invention will become apparent by describing in detail preferred embodiments thereof with reference to the attached drawings in which:

FIG. 1 illustrates a block diagram of an error-correction apparatus according to an embodiment of the present invention;

FIG. 2 illustrates a graph for explaining the estimation of a data variation by the error-correction apparatus illustrated in FIG. 1 using an extrapolation method;

FIG. 3 illustrates a flowchart of an error-correction method according to an embodiment of the present invention;

FIGS. 4 and 5 illustrate block diagrams of a three-dimensional (3D) pointing device using an error-correction apparatus, according to an embodiment of the present invention; and

FIG. 6 illustrates diagrams showing the error rate and an average moving time of the 3D pointing device illustrated in FIG. 4.

### DETAILED DESCRIPTION OF THE INVENTION

The present invention will now be described more fully with reference to the accompanying drawings, in which exemplary embodiments of the invention are shown. The invention may, however, be embodied in many different forms and should not be construed as being limited to the embodiments set forth herein. Rather, these embodiments are provided so that this disclosure will be thorough and complete, and will fully convey the concept of the invention to those skilled in the art. Like reference numerals in the drawings denote like elements, and thus their description will be omitted.

The present invention is described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded into a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

And each block of the flowchart illustrations may represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

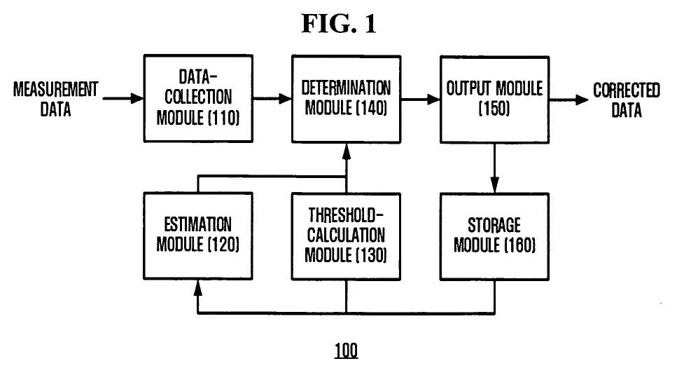

FIG. 1 illustrates a block diagram of an error-correction apparatus 100 according to an embodiment of the present invention. Referring to FIG. 1, the error-correction apparatus 100 includes a data-collection module 110, an estimation module 120, a threshold-calculation module 130, a determination module 140, an output module 150, and a storage module 160.

The data-collection module 110 collects data and calculates an actual variation in the data. The data-collection module 110 receives measurement data from a sensor (not shown) and calculates an actual variation in the measurement data. For example, an actual variation ΔPᵣ(k) in k-th data Pₖ may be calculated using the equation: ΔPᵣ(k)=Pₖ−Pₖ₋₁.

The data-collection module 110 stores data (hereinafter referred to as the current data) currently being collected by the data-collection module 110 and uses the current data to calculate a variation in data subsequent to the current data.

The storage module 160 stores previous data variations. If the current data is the k-th data Pₖ, the storage module 160 may store N previous data variations: ΔP(k−1), ΔP(k−2), Λ, and ΔP(k−N) where N is a natural number not less than 2. If the data-collection module 110 has not yet collected at least N sets of data, an estimated data variation and a variable threshold for the current data may not be properly calculated.

The estimation module 120 calculates an estimated data variation for the current data based on the N data variations present in the storage module 160. The estimation module 120 may use an extrapolation method to calculate an estimated data variation for the current data.

An extrapolation method is a method of estimating unknown data based on known data. Examples of the extrapolation method include a linear extrapolation method, a polynomial extrapolation method and a conic extrapolation method.

Specifically, the estimation module 120 calculates an estimated data variation ΔPₑ(k) for the k-th data Pₖ based on the N data variations present in the storage module 160 using an extrapolation method, as indicated by the equation: ΔPₑ(k)=f(ΔP(k−1), ΔP(k−2), . . . , ΔP(k−N)).

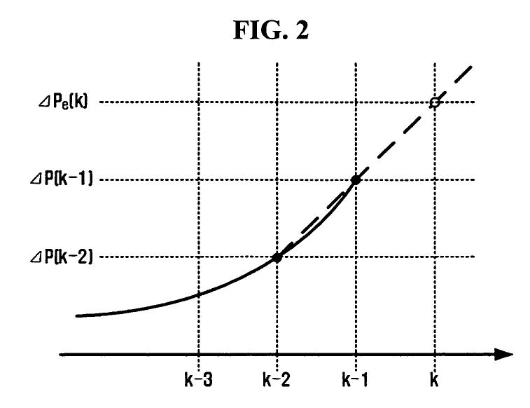

The calculation of the estimated data variation ΔPₑ(k) using an extrapolation method will be described later in further detail with reference to FIG. 2.

The threshold-calculation module 130 may calculate a variable threshold TH_{ΔP}(k) for the k-th data Pₖ based on the N data variations present in the storage module 160, as indicated by the equation: TH_{ΔP}(k)=g(ΔP(k−1), ΔP(k−2), . . . , ΔP(k−N)).

For example, the threshold-calculation module 130 may calculate the variable threshold TH_{ΔP}(k) using a standard deviation of the N data variations present in the storage module 160, as indicated by the equation: TH_{ΔP}(k)=G·std(ΔP(k−1), ΔP(k−2), . . . , ΔP(k−N)), where std represents a standard deviation and G represents gain. In the case of calculating the variable threshold TH_{ΔP}(k) using a standard deviation of the N data variations present in the storage module 160, the greater the recent data variations, the greater the variable threshold TH_{ΔP}(k). Thus, only a considerable data variation can be reflected in the calculation of the estimated data variation ΔPₑ(k). In contrast, the smaller the recent data variations, the smaller the variable threshold TH_{ΔP}(k). Thus, even a slight data variation can be reflected in the calculation of the estimated data variation ΔPₑ(k).

The determination module 140 compares the difference between the actual data variation ΔPᵣ(k) provided by the data-collection module 110 and the estimated data variation ΔPₑ(k) provided by the estimation module 120 with the variable threshold TH_{ΔP}(k) provided by the threshold-calculation module 130, and determines whether the k-th data Pₖ collected by the data-collection module 110 is erroneous based on the result of the comparison.

If the difference between the actual data variation ΔPᵣ(k) and the estimated data variation ΔPₑ(k) is greater than the variable threshold TH_{ΔP}(k), the determination module 140 determines that the k-th data Pₖ is erroneous, and returns the estimated data variation ΔPₑ(k) as a data variation ΔP(k) for the k-th data Pₖ.

Specifically, the determination module 140 determines whether k is greater than or the same as N. If k is determined to be less than N, the estimated data variation ΔPₑ(k) and the variable threshold TH_{ΔP}(k) may not be properly calculated, and, thus, the determination module 140 returns the actual data variation ΔPᵣ(k) as the data variation ΔP(k).

The output module 150 outputs the data variation ΔP(k) returned by the determination module 140, and stores the data variation ΔP(k) in the storage module 160 so that the data variation ΔP(k) can be used later to calculate an estimated data variation and a variable threshold for (k+1)-th data.

The term “module”, as used herein, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

FIG. 2 illustrates how the error-correction apparatus 100 illustrated in FIG. 1 estimates a data variation using an extrapolation method. Referring to FIG. 2, if N=2, the estimated data variation ΔPₑ(k) for the k-th data Pₖ may be calculated based on two previous data variations, i.e., a data variation ΔP(k−1) for (k−1)-th data and a data variation ΔP(k−2) for (k−2)-th data using a linear extrapolation method, as indicated by the following equation.

$$\begin{matrix}Δ {P}_{e} ( k ) = Δ P ( k - 2 ) + \frac{k - ( k - 2 )}{( k - 1 ) - ( k - 2 )} ( Δ P ( k - 1 ) - Δ P ( k - 2 ) ) \\ = 2 Δ P ( k - 1 ) - Δ P ( k - 2 )\end{matrix}$$

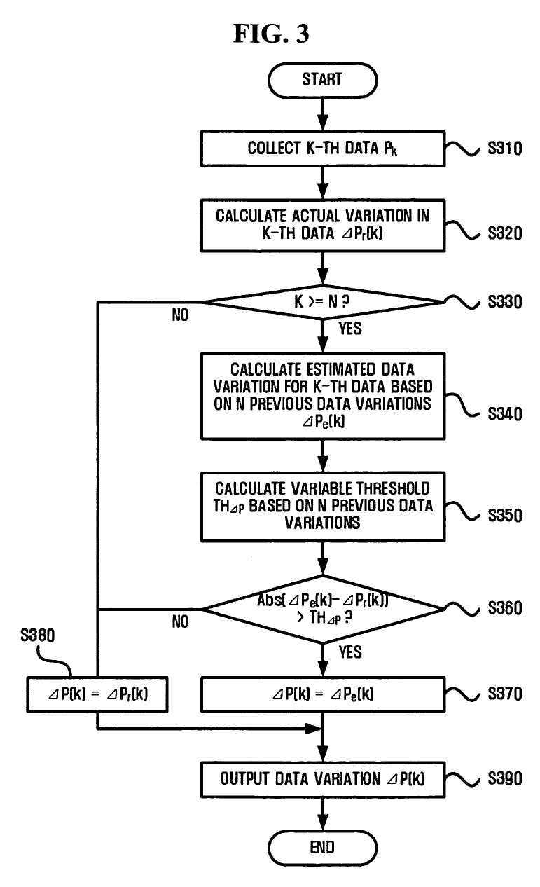

FIG. 3 illustrates a flowchart of an error-correction method according to an embodiment of the present invention. Referring to FIG. 3, the data-collection module 110 receives k-th data Pₖ (S310) and calculates an actual variation ΔPᵣ(k) in the k-th data Pₖ (S320). The data-collection module 110 may receive measurement data from a sensor (not shown) and calculate an actual variation in the measurement data. The actual data variation ΔPᵣ(k) may be calculated using the following equation: ΔPᵣ(k)=Pₖ−Pₖ₋₁.

Thereafter, it is determined whether k is greater than N, which is an integer not less than 2 (S330). If k is less than N, i.e., if the collection of data has not yet been performed at least N times, an estimated data variation and a variable threshold for the k-th data Pₖ may not be properly calculated. Thus, if k is less than N, the actual data variation ΔPᵣ(k) is output as a data variation ΔP(k) for the k-th data Pₖ (S380).

The estimation module 120 calculates an estimated data variation ΔPₑ(k) for the k-th data Pₖ based on N data variations present in the storage module 160 using an extrapolation method, as indicated by the following equation: ΔPₑ(k)=f(ΔP(k−1), ΔP(k−2), . . . , ΔP(k−N)). For example, if N=2, the estimation module 120 may calculate the estimated data variation ΔPₑ(k) using a linear extrapolation method, as indicated by the following equation: ΔPₑ(k)=2ΔP(k−1)−ΔP(k−2).

The threshold-calculation module 130 calculates a variable threshold for the k-th data Pₖ based on the N data variations present in the storage module 160 (S350), as indicated by the equation: TH_{ΔP}(k)=g(ΔP(k−1), ΔP(k−2), . . . , ΔP(k−N)). For example, the threshold-calculation module 130 may calculate the variable threshold TH_{ΔP}(k) using a standard deviation of the N data variations present in the storage module 160, as indicated by the equation: TH_{ΔP}(k)=G·std(ΔP(k−1), ΔP(k−2), . . . , ΔP(k−N)) where std represents a standard deviation and G represents gain.

The determination module 140 compares the difference between the actual data variation ΔPᵣ(k) provided by the data-collection module 110 and the estimated data variation ΔPₑ(k) provided by the estimation module 120 with the variable threshold TH_{ΔP}(k) provided by the threshold-calculation module 130, and determines whether the k-th data Pₖ collected by the data-collection module 110 is erroneous based on the result of the comparison S360.

Specifically, if the difference between the actual data variation ΔPᵣ(k) and the estimated data variation ΔPₑ(k) is greater than the variable threshold TH_{ΔP}(k), the determination module 140 determines that the k-th data Pₖ is erroneous, and returns the estimated data variation ΔPₑ(k) as a data variation ΔP(k) for the k-th data Pₖ (S370).

In contrast, if the difference between the actual data variation ΔPᵣ(k) and the estimated data variation ΔPₑ(k) is less than the variable threshold TH_{ΔP}(k), the determination module 140 returns the actual data variation ΔPᵣ(k) as the data variation ΔP(k) S380.

The output module 150 outputs the data variation ΔP(k) returned by the determination module 140 (S390). The output module 150 may store the data variation ΔP(k) in the storage module 160 so that the data variation ΔP(k) can be used later to calculate an estimated data variation and a variable threshold for (k+1)-th data.

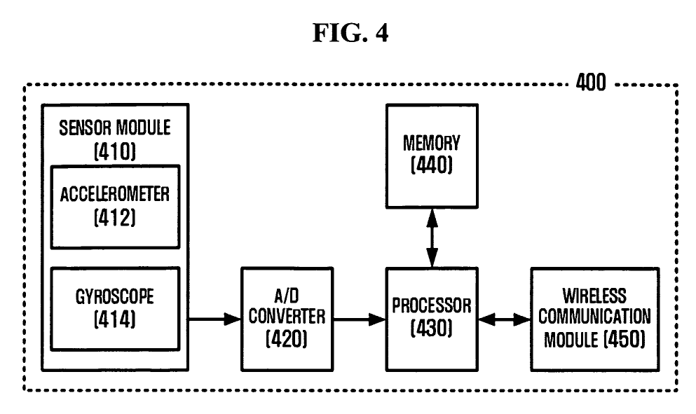

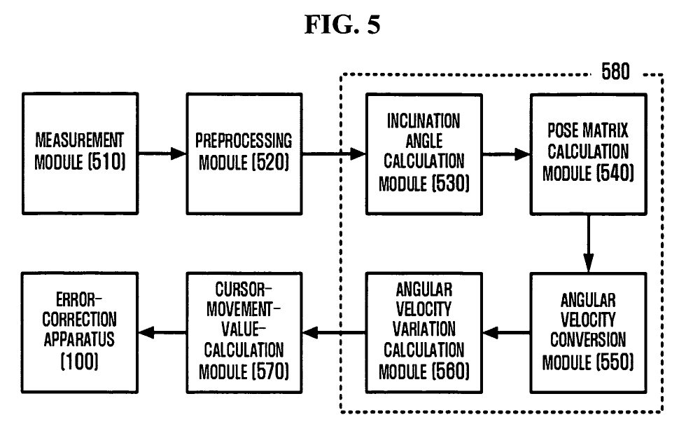

FIGS. 4 and 5 illustrate block diagrams of a three-dimensional (3D) pointing device 400 using an error-correction apparatus, according to an embodiment of the present invention. Referring to FIG. 4, the 3D pointing device 400 includes a sensor module, an analog-to-digital (A/D) converter 420, a processor 430, a memory 440 and a wireless communication module 450. The sensor module 410 includes an accelerometer 412 and a gyroscope 414.

The accelerometer 412 and the gyroscope 414 may output analog signals obtained by periodically sampling data at a rate of, for example, 100 samples/sec. The accelerometer 410, which is a triaxial accelerometer, outputs x-axis, y-axis, and z-axis acceleration values (Accₓ,Acc_{y},Acc_{z}) of the 3D pointing device 400. The gyroscope 414, which is a triaxial gyroscope, outputs x-axis, y-axis, and z-axis angular velocity values (Rotₓ,Rot_{y},Rot_{z}) of the 3D pointing device 400.

The A/D converter 420 converts analog signals into digital signals. Specifically, the A/D converter 420 converts the x-axis, y-axis, and z-axis acceleration values and the x-axis, y-axis, and z-axis angular velocity values (Accₓ,Acc_{y},Acc_{z},Rotₓ,Rot_{y},Rot_{z}), which are all analog values, into digital values (Aₓ,A_{y},A_{z},Wₓ,W_{y},W_{z}).

The processor 430 calculates a cursor movement value (Δx,Δy) by processing the digital values (Aₓ,A_{y},A_{z},Wₓ,W_{y},W_{z}) provided by the A/D converter 420. The processor 430 may use the error-correction method illustrated in FIG. 3 to process the digital values (Aₓ,A_{y},A_{z},Wₓ,W_{y},W_{z}); this will be described later in further detail with reference to FIG. 5.

The memory 440 stores programs and data that are necessary for the operation of the processor 430.

The wireless communication module 450 may transmit the cursor movement value (Δx,Δy) to an external device such as a personal computer which uses the 3D pointing device 400. In this case, the personal computer may include a wireless transmission module (not shown) to which the wireless communication module 450 of the 3D pointing device 400 is connected through a universal serial bus (USB). Thus, the personal computer may receive the cursor movement value (Δx,Δy) from the wireless communication module 450 of the 3D pointing device 400 and move a cursor according to the cursor movement value (Δx,Δy).

Referring to FIG. 5, the 3D pointing device 400 may also include a measurement module 510, a preprocessing module 520, a conversion module 580, a cursor-movement-value-calculation module 570 and an error-correction apparatus 100.

The conversion module 580 includes an inclination angle calculation module 530, a pose matrix calculation module 540, an angular velocity conversion module 550 and a rotation-angle-variation-calculation module 560.

The measurement module 510 receives acceleration values and angular velocity values (Aₓ,A_{y},A_{z},Wₓ,W_{y},W_{z}) of the 3D pointing device 400. The acceleration values and the angular velocities (A_{z},A_{y},A_{z},Wₓ,W_{y},W_{z}) are obtained by digitalizing analog acceleration values and analog angular velocity values measured by the sensor module 410 with the use of the A/D converter 420.

The preprocessing module 520 corrects the acceleration values and the angular velocities (Aₓ,A_{y},A_{z},Wₓ,W_{y},W_{z}) received by the measurement module 520. Specifically, the preprocessing module 510 corrects the acceleration values and the angular velocities (Aₓ,A_{y},A_{z},Wₓ,W_{y},W_{z}) received by the measurement module 520 using a scale and a deviation value corresponding to a system including the 3D pointing device 400, and removes high-frequency noise from the corrected acceleration values and the corrected angular velocity values by passing the corrected acceleration values and the corrected angular velocity values through a low pass filter. As a result, the preprocessing module 520 returns preprocessed acceleration values and preprocessed angular velocity values (αₓ,α_{y},α_{z},ωₓ,ω_{y},ω_{z}).

The inclination angle calculation module 530 calculates a pitch angle θ and a roll angle γ based on the preprocessed acceleration values and the preprocessed angular velocity values (αₓ,α_{y},α_{z},ωₓ,ω_{y},ω_{z}) returned by the preprocessing module 520.

Specifically, the inclination angle calculation module 530 may calculate the pitch angle θ and the roll angle γ using the equations: θ=tan⁻¹(−αₓ/\sqrt{(α_{y})²+(α_{z})²}) and γ=tan⁻¹(α_{y},α_{z}).

The pose matrix calculation module 540 calculates a pose matrix Cₙ^{b}, which is a matrix for converting a navigation frame into a body frame, based on the pitch angle θ and the roll angle γ calculated by the inclination angle calculation module 530. The body frame is a frame of the 3D pointing device 400, and the navigation frame is a frame of the system including the 3D pointing device 400. The pose matrix Cₙ^{b} calculated by the pose matrix calculation module 540 may be represented by the equations:

$${C}_{n}^{b} = [ \begin{matrix}cos θ cos ψ & cos θ sin ψ & - sin θ \\ - cos γ sin ψ + sin γ sin θ cos ψ & cos γcos ψ + sin γ sin θ sin ψ & sin γ cos θ \\ sin γ sin ψ + cos γ sin θ cos ψ & - sin γ cos ψ + cos γ sin θ sin ψ & cos γcos θ\end{matrix} ] \\ and \\ {C}_{b}^{n} = {( {C}_{n}^{b} )}^{- 1} = {( {C}_{n}^{b} )}^{- 1} .$$

The angular velocity conversion module 550 converts angular velocity values of the body frame, i.e., the angular velocity values (ωₓ,ω_{y},ω_{z}) into angular velocity values (ωⁿ=[ωₓⁿ ω_{y}ⁿ ω_{z}ⁿ]^{T}) of the navigation frame using the pose matrix Cₙ^{b}, as indicated by the equation:

$${ω}^{n} = {C}_{b}^{n} ( \begin{matrix}{ω}_{x} \\ {ω}_{y} \\ {ω}_{z}\end{matrix} ) .$$

The rotation-angle-variation-calculation module 560 two rotation angle variations Δθ_{y} and Δθ_{z} based on the angular velocity values (ωⁿ=[ωₓⁿ ω_{y}ⁿ ω_{z}ⁿ]^{T}) provided by the angular velocity conversion module 550, as indicated by the equations:

Δθ_{y}=ω_{y}ⁿΔt

Δθ_{z}=ω_{z}ⁿΔt′

where Δt indicates a time interval for sampling data. If data sampling is performed at a rate of 100 samples/sec, the time interval Δt may be 0.01 sec.

The cursor-movement-value-calculation module 570 calculates a cursor movement value based on the rotation angle variations Δθ_{y} and Δθ_{z} calculated by the rotation-angle-variation-calculation module 560. The cursor movement value includes a horizontal cursor movement value Δx and a vertical cursor movement value Δy. The horizontal cursor movement value Δx and the vertical cursor movement value Δy may be calculated using the equations:

Δx=K_{gainz}Δθ_{z}

Δy=K_{gainy}Δθ_{y}′

where K_{gainx} and K_{gainy} indicate gain for the x-axis and gain for the y-axis, respectively.

The error-correction apparatus 100 corrects an error, if any, in the cursor movement value (Δx,Δy) using a variable threshold which is calculated based on a number of data variations regarding the cursor movement value (Δx,Δy). The error-correction apparatus 100 may correct an error caused by noise or a measurement error of the sensor module 410 or mishandling of the 3D pointing device 400. The operation of the error-correction apparatus 100 has already been described above, and thus, a detailed description of the operation of the error-correction apparatus 100 will be skipped.

The measurement module 510, the preprocessing module 520, the inclination angle calculation module 530, the pose matrix calculation module 540, the angular velocity conversion module 550, the rotation-angle-variation-calculation module 560, the cursor-movement-value-calculation module 570 and the error-correction apparatus 100 may all be included in the memory 440 and executed by the processor 430.

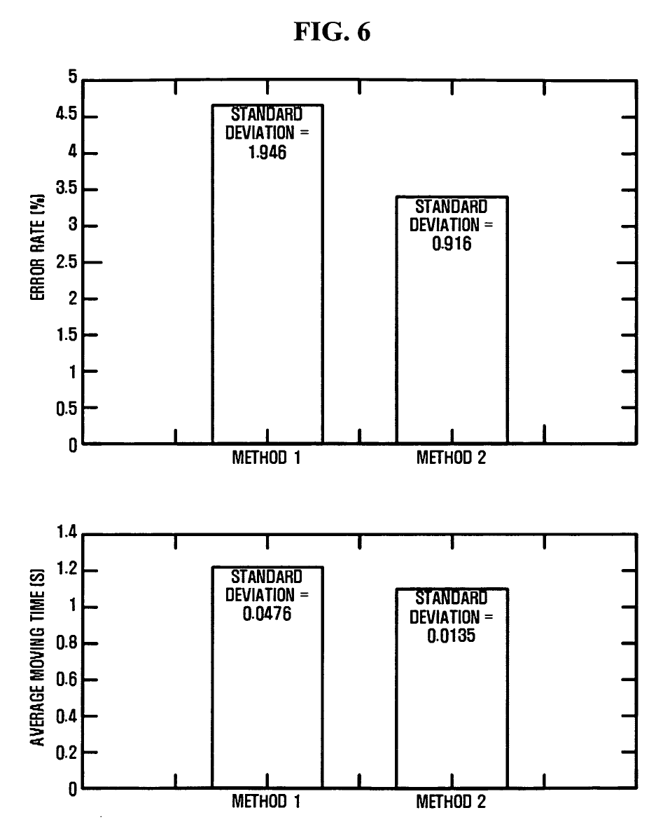

FIG. 6 illustrates diagrams showing the error rate and an average moving time of the 3D pointing device 400 illustrated in FIG. 4. Referring to FIG. 6, method 1 corresponds to a method that involves the use of a 3D pointing device including an error-correction apparatus, and method 2 corresponds to a method that involves the use of a 3D pointing device including no error-correction apparatus. Six experimenters participated in an experiment for testing methods 1 and 2 by pointing at two separate points using a 3D pointing device using an error-correction apparatus and a 3D pointing device not using an error-correction apparatus; the results of the experiment are illustrated in FIG. 6.

Referring to FIG. 6, the error rate of method 1 is 4.66% (standard deviation: 1.946%) whereas the error rate of method 2 is 3.429% (standard deviation: 0.916%), which is more than 1% lower than the error rate of method 1.

Also, the average moving time of method 1 is 1.2021 s (standard deviation: 0.0476 sec) whereas the average moving time of method 2 is 1.1512 s (standard deviation: 0.0135 sec), which is more than 0.05 s shorter than the average moving time of method 1.

Therefore, referring to FIG. 6, it is possible to efficiently perform a pointing operation at high speed using a 3D pointing device.

As described above, the present invention has the following advantages.

First, it is possible to effectively correct an error caused by noise or a measurement error of a sensor or mishandling of a sensor.

Second, it is possible to effectively correct an error by reflecting recent data variations using a variable threshold.

Third, it is possible to provide a 3D pointing device capable of reducing malfunction by removing unnecessary pointer movements from a screen.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An error-correction apparatus comprising:
a data-collection module which collects current data and calculates an actual variation in the current data;
an estimation module which calculates an estimated data variation for the current data based on a number of data variations for respective corresponding previous data;
a threshold-calculation module which calculates a variable threshold based on the data variations for the respective previous data; and
a determination module which compares a difference between the actual data variation and the estimated data variation with the variable threshold and determines whether the current data is erroneous based on the result of the comparison.

2. The error-correction apparatus of claim 1, wherein the data variations for the previous data comprise at least two data variations for respective corresponding previous data.

3. The error-correction apparatus of claim 1, wherein the estimation module calculates the estimated data variation based on at least two data variations for respective corresponding previous data using an extrapolation method.

4. The error-correction apparatus of claim 1, wherein the threshold-calculation module calculates the variable threshold based on a standard deviation of at least two data variations for respective corresponding previous data.

5. The error-correction apparatus of claim 1, wherein the determination module returns the estimated data variation as a data variation for the current data if the difference between the actual data variation and the estimated data variation is greater than the variable threshold.

6. The error-correction apparatus of claim 1, wherein the determination module returns the actual data variation as a data variation for the current data if the difference between the actual data variation and the estimated data variation is less than the variable threshold.

7. The error-correction apparatus of claim 1, wherein the determination module returns the actual data variation as a data variation for the current data if the order of the current data is less than the number of data variations for respective corresponding previous data.

8. An error-correction method comprising:
calculating an actual variation in data currently being collected;
calculating an estimated data variation for the current data based on a number of data variations for respective corresponding previous data;
calculating a variable threshold based on the data variations for the respective previous data; and
comparing the difference between the actual data variation and the estimated data variation with the variable threshold, and determining whether the current data is erroneous based on the result of the comparison.

9. The error-correction method of claim 8, wherein the data variations for the previous data comprise at least two data variations for respective corresponding previous data.

10. The error-correction method of claim 8, wherein the calculating of the estimated data variation comprises using an extrapolation method.

11. The error-correction method of claim 8, wherein the calculating of the variable threshold comprises calculating the variable threshold based on a standard deviation of at least two data variations for respective corresponding previous data.

12. The error-correction method of claim 8, further comprising, if the difference between the actual data variation and the estimated data variation is greater than the variable threshold, returning the estimated data variation as a data variation for the current data.

13. The error-correction method of claim 8, further comprising, if the difference between the actual data variation and the estimated data variation is less than the variable threshold, returning the actual data variation as a data variation for the current data.

14. The error-correction method of claim 8, further comprising, if an order of the current data is less than a number of data variations for respective corresponding previous data, returning the actual data variation as a data variation for the current data.

15. A three-dimensional (3D) pointing device including an error-correction apparatus, comprising:
a measurement module which receives acceleration values and angular velocity values of a body frame;
a conversion module which converts the angular velocity values of the body frame into angular velocity values of a navigation frame using the acceleration values of the body frame;
a rotation-angle-variation-calculation module which calculates rotation angle variations based on the angular velocity values of the navigation frame;
a cursor-movement-value-calculation module which calculates a cursor movement value based on the rotation angle variations; and
an error-correction apparatus which corrects an error in the cursor movement value using a variable threshold, the variable threshold being determined based on a number of data variations regarding the cursor movement value.

16. The 3D pointing device of claim 15, further comprising a preprocessing module which corrects the acceleration values and the angular velocity values of the body frame using a scale and a deviation value corresponding to a system comprising the 3D pointing device.

17. The 3D pointing device of claim 15, wherein the conversion module comprises:
an inclination angle calculation module which calculates a pitch angle and a roll angle based on the acceleration values of the body frame;
a pose matrix calculation module which calculates a pose matrix for converting a navigation frame into a body frame based on the pitch angle and the roll angle; and
an angular velocity conversion module which converts the angular velocity values of the body frame into the angular velocity values of the navigation frame using the pose matrix.

18. The 3D pointing device of claim 15, wherein the error-correction apparatus comprises:
a data-collection module which calculates an actual variation in data currently being collected regarding the cursor movement value;
an estimation module which calculates an estimated data variation for the current data based on a number of data variations for respective corresponding previous data;
a threshold-calculation module which calculates a variable threshold based on the data variations for the respective previous data; and
a determination module which compares a difference between the actual data variation and the estimated data variation with the variable threshold and determines whether the current data is erroneous based on the result of the comparison.

19. A 3D pointing device comprising:
a sensor module which measures an acceleration and an angular velocity and outputs the results of the measurement as analog signals;
an analog-to-digital (A/D) converter which converts the analog signals into digital signals;
a processor which calculates a cursor movement value by processing the digital signals, and corrects an error in the cursor movement value using a variable threshold, the variable threshold being determined based on a number of data variations regarding the cursor movement value; and
a memory which stores programs and data that are necessary for an operation of the processor.

20. The 3D pointing device of claim 19, wherein the processor corrects the error in the cursor movement value using an error-correction method, the method comprising:
calculating an actual variation in data currently being collected regarding the cursor movement value;
calculating an estimated data variation for the current data based on a number of data variations for respective corresponding previous data;
calculating a variable threshold based on the data variations for the respective previous data; and
comparing a difference between the actual data variation and the estimated data variation with the variable threshold and determining whether the current data is erroneous based on the result of the comparison.

21. The 3D pointing device of claim 19, wherein the memory comprises:
a measurement module which receives acceleration values and angular velocity values of a body frame;
a conversion module which converts the angular velocity values of the body frame into angular velocity values of a navigation frame using the acceleration values of the body frame;
a rotation-angle-variation-calculation module which calculates rotation angle variations based on the angular velocity values of the navigation frame;
a cursor-movement-value-calculation module which calculates a cursor movement value based on the rotation angle variations; and
an error-correction apparatus which corrects an error in the cursor movement value using a variable threshold, the variable threshold being determined based on a number of data variations regarding the cursor movement value.

22. The 3D pointing device of claim 21, wherein the error-correction apparatus comprises:
a data-collection module which calculates an actual variation in data currently being collected regarding the cursor movement value;
an estimation module which calculates an estimated data variation for the current data based on a number of data variations for respective corresponding previous data;
a threshold-calculation module which calculates a variable threshold based on the data variations for the respective previous data; and
a determination module which compares a difference between the actual data variation and the estimated data variation with the variable threshold and determines whether the current data is erroneous based on the result of the comparison.
